(19) United States
(12) Patent Application Publication
(10) Pub. No.: US 2016/0145547 A1
(43) Pub. Date: May 26, 2016

(54) Film-Encased Cleaning Composition

(71) Applicant: Milliken & Company, Spartanburg, SC (US)

(72) Inventors: Emily W. Michaels, Taylors, SC (US); Laurent D. Kieken, Greenville, SC (US); Shirley A. Whiteside, Chesnee, SC (US); Patrick D. Moore, Pacolet, SC (US); Randy D. Petrea, Boiling Springs, SC (US); Robert L. Schuette, Duncan, SC (US)

(21) Appl. No.: 14/937,916

(22) Filed: Nov. 11, 2015

Related U.S. Application Data
(60) Provisional application No. 62/083,979, filed on Nov. 25, 2014.

(51) Int. Cl. C11D 17/04; C11D 3/20; C11D 3/22; C11D 3/04; C11D 3/10; C11D 3/33; C11D 3/39

(52) U.S. Cl. CPC C11D 17/044; C11D 3/33; C11D 3/2086; C11D 3/2065; C11D 3/3942; C11D 3/042; C11D 3/10; C11D 3/221

(57) ABSTRACT

This invention relates to a cleaning composition encased within a film material. The film-encased cleaning composition is useful for cleaning appliances, such as washing machines.

### CROSS REFERENCE TO RELATED APPLICATIONS

This application claims priority to U.S. Provisional Patent Application No. 62/083,979, entitled “Film-Encased Cleaning Composition” which was filed on Nov. 25, 2014.

### TECHNICAL FIELD

This invention relates to a cleaning composition encased within a film material. The film-encased cleaning composition is useful for cleaning appliances, such as washing machines.

### BACKGROUND

Many different types of cleaning compositions have been developed for use in preventing and controlling the growth of microbes. These include, for example, bleach compositions and detergent formulations that include bleach compositions. However, with the continual introduction of new consumer products, there exists a constant demand in the marketplace for protection against bacterial and fungal growth presented by some of these new products. Of particular concern, the present invention is directed toward reducing and/or eliminating the growth of microbes and biofilm in home appliances and/or equipment that have water contact surfaces. Examples of home appliances having water contact surfaces include washing machines, dishwashing machines, coffee-making machines, and the like. Other equipment having water contact surfaces include whirlpool-type bathtubs, in-home humidifiers and de-humidifiers, air conditioning units, dishwashers, and the like.

Using the example of washing machines, the growth and proliferation of microbes in a washing machine generally occurs from prolonged exposure to warm, moist environments which may contain soap residue and clothing residue, such as body oils, fiber particles, and dirt and bacteria from the clothing. This environment leads to the development of undesirable odors and biofilm. Biofilm is the growth of microbes, such as bacteria and fungi, on a surface. Biofilms are commonly surrounded by an exopolymeric matrix. Both the abundant microbial growth and matrix production result in visible microbial communities, thus damaging the aesthetic appeal of the surface. Additionally, secondary metabolites produced as a result of microbial growth include volatile organic compounds (VOCs) that can be detected by the consumer as foul odors.

Front loading laundry machines, in particular, provide an ideal environment for microbial growth in any of the water-contact locations in the machine. The four major components of the machine are generally the polypropylene wash tub, stainless steel wash cylinder, aluminum support bracket and the circular door sealing gasket (also known as a “bellow”) which provides a seal between the wash compartment and the door of the washing machine. Biofilms may form on the washing machine bellow, on the piping and tubing which connects the parts and carries the water to and from the machine, on the inner surface of the outer wash tub and on the outer surface of the inner wash tub. As the microbes in the biofilm grow, they tend to penetrate the supporting surface resulting in staining of the surface to which the microbes attach. Microbial growth further leads to degradation of the machine parts which potentially results in reduced life cycle of the parts or the entire laundry machine. Additionally, in the process of biofilm growth and maturation, portions of the biofilm may detach and come into contact with clothing, towels, sheets, etc. that are laundered in the washing machine. This biofilm-to-clothing contact may undesirably and irreversibly stain and leave a residual odor on the clothing that comes into contact with the detached biofilm during the laundering process.

Both top loading and front loading washing machines experience foul odors (both in the machine and transferred to the clothes) as well as mold and staining issues. These problems are thought to originate from biofilm formation on components comprising the washers. The staining on the rubber door bellow is often visible to the consumer after several months. Foul odors caused by the biofilm in other areas of the machine are often noticeable within three months of field use. In worst case scenarios, the odor from the machine is transferred to the clothing.

This problem of microbial growth and proliferation in appliances and equipment having water contact surfaces, particularly in washing machines, has been manifested, in part, by the desire to manufacture more energy efficient and environmentally friendly consumer products. For instance, the laundry care industry is producing high efficiency washing machines designed to clean clothing at lower wash water temperatures. Regulations restricting water volumes in such appliances and the use of excessive liquid laundry detergents have been mandated in some countries. Thus, increased production of front loading washing machines and machines designed to clean clothing at lower temperatures and lower water volumes has created a need for cleaning compositions capable of reducing and/or eliminating microbial growth on water contact surfaces contained within these machines.

One remedy to this problem that is provided by washing machine manufacturers is to include a cleaning cycle as part of the standard offering on the machine cycle dial. Thus, the user care guide and machine cycle dial recommends to machine owners that they should run a periodic cleaning cycle on the machine using a large amount of bleach. In some washing machine models, such as the high efficiency front loading machine, an indicator maintenance light is built into the machine. The light is designed to turn on at regular time intervals (e.g. every 30 days, every six months, etc.) as a reminder to the consumer that it is time to run a cleaning cycle in the machine.

For instance, US Patent Publication Nos. 2005/0262883 to Yang et al., 2005/0265890 to Yang et al., and 2005/0262645 to Yang et al. disclose a washing machine having a deodorizing unit contained therein for removing odors from objects placed in the wash tub. An electronic nose sensor generates a response based on the type and kind of odor particles or gas present in the tub. Odors are removed by spraying water onto the objects in the tub and blowing hot air, thereby moving the offensive odor particles to an air outlet present on one side of the tub. This deodorizing cycle is operated separately from the wash cycle. In addition to the deodorizing unit, the washing machine may also possess an ozone-generating unit and/or an ultraviolet lamp for deodorizing objects.

Additionally, U.S. Pat. No. 6,463,766 to Kubota et al. discloses a washing machine with means for preventing propagation of microorganisms. The washing machine is manufactured with a deposition section in the water supply hose from the water source to the wash tub (i.e., a split water line) which also includes a solid antimicrobial agent disposed therein. The solid antimicrobial agent is contained in a cassette case. Upon contact with water, the solid antimicrobial agent, e.g. an organic compound having nitrogen and halogen atoms, releases the antimicrobial agent, e.g. hypohalogenous acid, into the water of the washing machine. The antimicrobial mode is provided as a cycle on the washing machine which the consumer can choose to activate. This product requires a filter for catching any pieces of the antimicrobial agent that breaks off from the solid shape and may enter the washing machine. If the pieces were to enter the washing machine, the antimicrobial agent may discolor the laundry items contained in the wash tub. The cycle time for running the antimicrobial agent into the machine is also longer than the normal wash cycle.

Other attempts to control this problem are addressed by US Patent Publication No. 2003/0008085 to Davenet et al. which discloses a laundry bag for holding soiled laundry in a washing machine. The laundry bag may include a dispensing unit which allows for the delayed release of a bleaching agent into the washing machine.

Thus, since washing machines are currently being designed to have a cleaning cycle built in for use by the consumer in preventing/removing microbial growth, the need exists for chemical compositions which may be added to the machine for use during this cleaning cycle. Attempts by others to create cleaning compositions for use in appliances and equipment as described herein have included bleach or bleach-containing compositions and other peroxide-based compositions which, as will be shown by example herein, fail to adequately clean and remove microbes, biofilm and any other buildup from the interior of machines having water contact surfaces. Furthermore, the use of bleach or bleach-containing products (e.g. chlorine bleach products) often leads to corrosion problems on various parts within the machine.

The present disclosure addresses and overcomes the problems described above. As one potentially preferred embodiment of the present invention, the film-encased cleaning composition is generally comprised of granular powder contained within a film encasing or pouch. The cleaning composition in the form of a granular powder is generally comprised of (a) a majority by weight of a percarbonate-based compound, such as sodium percarbonate, (b) a metal chelating agent, such as EDTA and/or an organic acid such as citric acid or tartaric acid, and (c) an organic acid component, such citric acid or tartaric acid. In some cases, the chelating agent and the acid component may be the same compound or may be different compounds. The cleaning composition may optionally include a diluent/filler such as sodium carbonate, sodium bicarbonate, potassium carbonate, potassium bicarbonate, talc, polyethylene glycols, polyols, sugars, cyclodextrins, starches, natural gums, cellulose gums, microcrystalline cellulose, methylcellulose, cellulose ethers, sodium carboxymethylcellulose, ethyl cellulose, gelatin, polyvinylpyrrolidone, pectins, alginates, polyacrylamides, polyvinyloxoazolidone, polyvinylalcohols, and the like, and combinations thereof; a fragrance; a preservative such as sodium benzoate; and/or an anti-corrosive agent such as sodium benzoate, salts of carboxylic acids, and anhydrides. The composition is ideally suited for reducing and/or eliminating microbial growth, including biofilm growth and scum build up contained within and/or on appliances, particularly those appliances that have water contact surfaces such as washing machines and dishwashers. Unlike many of the solutions previously described, the composition of the present invention does not have a negative effect on the machine parts, clothes, tableware, septic/sewer system, etc. Additionally, the composition has been designed to work with the machine cycle conditions (time, temperature, water volume, etc.) and to reduce or eliminate both the biological and the abiotic build up. For these reasons and others that will be described herein, the present film-encased cleaning composition represents a useful advance over the prior art.

### BRIEF SUMMARY

This invention relates to a film-encased cleaning composition comprised of: (a) a granular cleaning material, wherein the cleaning material is comprised of: (i) a majority by weight of a percarbonate-based compound; (ii) an organic acid component; (iii) a metal chelating agent; and (iv) optionally, at least one component selected from the group consisting of a diluent, a filler, a preservative, an anti-corrosion agent, and a fragrance; and (b) a film component, wherein the film component is polymeric, and wherein the film forms an enclosure that surrounds the granular cleaning material such that the granular cleaning material is contained within the film enclosure.

In another aspect, this invention relates to a process for cleaning an automatic washing machine comprising the following steps: (a) providing an automatic washing machine having a wash tub and a cleaning cycle; (b) adding the film-encased cleaning composition of claim 1 to the wash tub of the automatic washing machine; (c) activating the cleaning cycle of the automatic washing machine; (d) allowing the cleaning cycle to dissolve the film component of the film-encased cleaning composition; (e) allowing the cleaning cycle to disperse the granular cleaning material into the wash tub of the automatic washing machine; and (f) allowing the granular cleaning material to clean the automatic washing machine.

In a further aspect, this invention relates to a non-oxidizer solid cleaning composition comprising (a) a film component, and (b) a granular cleaning composition comprising a majority by weight of a percarbonate-based compound, a flame retardant system, and a carboxylic acid compound.

In yet another aspect, this invention relates to a method for cleaning an automatic washing machine comprising the sequential steps of: (a) providing an automatic washing machine having a wash tub; (b) adding a film-encased cleaning composition to the wash tub, wherein the cleaning composition comprises a majority by weight of a percarbonate-based compound, a flame retardant system, and a carboxylic acid compound; (c) adding a sufficient amount of water to the wash tub to allow the cleaning composition to dissolve and form a mixture of water and cleaning composition; (d) agitating the mixture of step “c”; (e) removing the mixture of step “c” from the wash tub; and (f) rinsing the wash tub.

### DETAILED DESCRIPTION

The present invention relates to a film-encased cleaning composition useful for cleaning appliances. The cleaning composition is generally provided in granular or powder form and is encased or enveloped in a film material. The cleaning composition in the form of a granular powder is generally comprised of (a) a majority by weight of a percarbonate-based compound, such as sodium percarbonate, (b) a metal chelating agent, such as EDTA and/or an organic acid such as citric acid or tartaric acid, and (c) an organic acid component, such citric acid or tartaric acid. In some cases, the chelating agent and the acid component may be the same compound or may be different compounds. The cleaning composition may optionally include a diluent/filler such as sodium carbonate, sodium bicarbonate, potassium carbonate, potassium bicarbonate, talc, polyethylene glycols, polyols, sugars, cyclodextrins, starches, natural gums, cellulose gums, microcrystalline cellulose, methylcellulose, cellulose ethers, sodium carboxymethylcellulose, ethyl cellulose, gelatin, polyvinylpyrrolidone, pectins, alginates, polyacrylamides, polyvinyloxoazolidone, polyvinylalcohols, and the like, and combinations thereof; a fragrance; a preservative such as sodium benzoate; and/or an anti-corrosive agent such as sodium benzoate, salts of carboxylic acids, and anhydrides.

Percarbonate-based compounds include, for example, sodium percarbonate compounds. Sodium percarbonate is also known by other names such as sodium carbonate peroxyhydrate and sodium carbonate peroxide.

One commercially available percarbonate-based product suitable for the solid cleaning composition of the present invention is FB® 400 sodium percarbonate available from Solvay Chemicals. This product is a free flowing white granular powder and has an average particle size of 400-550 microns. This product also contains an active available oxygen content equivalent to 27.5% hydrogen peroxide.

In one aspect, the percarbonate-based compound may be present in the range from 1% to 95% by weight of the total composition, from 10% to 75% by weight, from 30% to 75% by weight, or in the range from 50% to 70% by weight of the total composition. Thus, the percarbonate-based compound may comprise a majority by weight of the cleaning composition.

The metal chelating agent may be selected from the group consisting of ethylene diamine tetracetic acid (“EDTA”), tetraacetylethylenediamine (“TAED”), water soluble carboxylic acid compounds (including tartaric acid, citric acid, glycolic acid, aspartic acid, malic acid, fumaric acid, adipic acid, and the like and mixtures thereof), and combinations thereof. The metal chelating agent may aid in the removal of deposits from the machine and/or to remove calcium from the biofilm to weaken its structure and allow for easier removal of the biofilm. In one aspect, the metal chelating agent may be present in the range from 0.001% to 30% by weight of the total composition, from 0.01% to 20% by weight, from 0.1% to 15% by weight of the total composition, or from 1% to 10% by weight of the total composition.

The acid component may be selected based on its functionality and compatibility with the other ingredients of the cleaning composition. Functionality may include features such as effervescence, dissolution rate, and the like. It may be also be preferable to choose acid components that are readily available in powder form. Examples of suitable acid components include carboxylic acids such as malic acid, tartaric acid, gluconic acid, citric acid, succinic acid, fumaric acid, adipic acid, lactic acid, and the like, and mixtures thereof. The carboxylic acids tend to provide an effervescent feature to the cleaning composition. Additional non-limiting examples of acid components include lactic acid and boric acid. Mixtures of any of the foregoing acid components may be utilized.

In one aspect, the acid component may be present in the range from 0.001% to 60% by weight of the total composition, from 0.01% to 40% by weight, from 0.1% to 30% by weight of the total composition, or from 1% to 15% by weight of the total composition.

The cleaning composition may optionally include a preservative such as sodium benzoate. The cleaning composition may also include an anti-corrosive agent such as sodium benzoate, salts of carboxylic acids, and anhydrides.

The film component is present to encapsulate, encase and/or contain the granular powder cleaning composition. The film component is comprised of a polymeric material. The film component is comprised materials selected from the group consisting of polyvinyl alcohol, polyethylene, polypropylene, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum, and the like, or combinations thereof. In one aspect, the thickness of the film is in the range from 1 micron to 300 microns, in the range from 2 microns to 200 microns, in the range from 5 microns to 150 microns, or in the range from 10 microns to 100 microns.

The film component is preferably characterized in that it is water-soluble or water-dispersible. The film component is also characterized in being at least, in part, translucent or transparent. Transparent is intended to mean that the transmissivity within the visible spectrum of light (410 to 800 nm) is greater than 20%, preferably greater than 30%, more preferably greater than 40%, and even more preferably greater than 50%. At the point when the wavelength of the visible spectrum of light exhibits a transmissivity greater than 20%, it is considered to be transparent for the purposes of the present inventions.

The specific shape of the film-encased cleaning composition may be adapted depending upon its end-use application. Thus, the film-encased cleaning composition may be in the shape of a rectangle, a disk, a tube, a cylinder, a bottle, or the like.

One or more optional ingredients may be added to the film-encased cleaning composition. For example, a compound which provides a desirable odor to the cleaning composition, such as a fragrance or perfume, may be included in the cleaning composition. A fragrance, or perfume, may be any compound known to impart a desirable odor to a composition. A fragrance may be included in the composition to leave the machine with a fresh, clean scent after removal of the odor-causing microbes and biofilm. The fragrance may be comprised of naturally occurring compounds, or it may be comprised of synthetically made compounds. Fragrances may include, merely as an example, oils, such as citric oils. In one aspect, the fragrance may be present in the range from 0.001% to 20% by weight of the total composition, in the range from 0.01% to 10% by weight, in the range from 0.1% to 5% by weight, or in the range from 0.1% to 3% by weight of the total composition.

A diluent/filler may also be included in the film-encased cleaning composition. The diluent/filler can be for example, sodium carbonate, sodium bicarbonate, potassium carbonate, potassium bicarbonate, talc, polyethylene glycols, polypropylene glycols, polyols, sugars, cyclodextrins, starches, natural gums, cellulose gums, microcrystalline cellulose, methylcellulose, cellulose ethers, sodium carboxymethylcellulose, ethyl cellulose, gelatin, polyvinylpyrrolidone, pectins, alginates, polyacrylamides, polyvinyloxoazolidone, polyvinylalcohols, and the like, and mixtures thereof. In the case where the filler/diluent is a carbonate compound, it may be preferable that the compound has a particle size that is smaller than the percarbonate-based compound. Accordingly, the carbonate-based filler may complement the percarbonate-based compound, by occupying the small spaces between the percarbonate-based compounds. Also, the filler/diluent may serve as a carrier for other compounds present in the cleaning composition. For example, the filler/diluent may serve as a carrier for liquid ingredients that are added to the composition. In this capacity, the filler/diluent may assist in providing a cleaning composition in which all of the ingredients are uniformly dispersed within the composition.

In one aspect, the filler/diluent compound may be present in the range from 0.001% to 90% by weight of the total composition, from 1% to 60% by weight, from 5% to 35% by weight, from 10% to 30% by weight, or even from 1% to 5% by weight of the total composition.

Other ingredients may be added to the solid cleaning composition, depending on the specific end-use of the composition. These additives may include, for example, defoamers or antifoaming agents, surfactants, preservatives, pesticides, flame retardants, coloring agents, antifungal agents, antimicrobial agents, effervescents, slow release agents, coating agents, soil release agents, anticorrosion agents, fillers, deodorizers, and the like, and mixtures thereof. In one aspect, these other additives may be present in the range from 0.001% to 25% by weight of the cleaning composition, in the range from 0.01% to 15% by weight, and in the range from 0.1% to 5% by weight of the cleaning composition.

Suitable flame retardants include alkali and alkali earth metal hydroxides, carbonates and sulfates, aluminum hydroxide, hydroxide and carbonate minerals containing aluminum and calcium or magnesium, and combinations thereof. Preferably, the flame retardants are soluble in water. Most preferably the flame retardants are alkali and alkali earth metal sulfates and preferably, magnesium sulfate and sodium sulfate. The combination of sodium sulfate and magnesium sulfate also improves the dissolution rate of the cleaning composition so that no solid residues remain at the end of the cleaning cycle. As used herein, improved dissolution rate refers to the optimized rate of dissolution for the cleaning composition as it is used in conjunction with the cleaning cycle of an automatic washing machine (or other appliance). In other words, the cleaning composition of the present invention is designed to dissolve at an optimum speed with respect to the time and water temperature of the cleaning cycle of an automatic washing machine (or other appliance). In one aspect, the flame retardant is present in the range from 5% to 40% by weight of the total cleaning composition.

A defoamer or antifoaming agent may be desired to aid in the prevention or reduction of foaming during the cleaning cycle. Non-limiting examples of defoamers include silicone-containing compounds, mineral oils, fatty acids, and the like, and combinations thereof.

Additional alkalinity sources besides peroxide containing ingredients can be used to enhance cleaning performance. Suitable alkalinity ingredients include alkali metal salts, such as carbonates, alkali metal hydroxides or silicates, or the like. Examples include sodium or potassium hydroxide, sodium or potassium silicate or metasilicate or metasilicate pentahydrate. Other sources of alkalinity include ethanolamines and amines and the like.

Surfactants may be added to help reduce the surface tension of the water in the washing machine and/or to loosen the deposits for removal. The surfactant may be selected from the group consisting of anionic surfactants, cationic surfactants, nonionic surfactants, inorganic surfactants, and combinations thereof. Nonionic surfactants, inorganic surfactants and combinations thereof may be preferred surfactants. Specific examples of these preferred surfactants include quaternary ammonium compounds, amines (such as coco alkyl dimethyl amine), alcohol ethoxylates (such as lauryl alcohol ethoxylate), alkylene oxide polymers and copolymers (such as ethylene oxide/propylene oxide block copolymers) and combinations thereof.

Suitable deodorizers may include zinc-containing compounds. For example, zinc ricinoleate, zinc undecylenate, and combinations thereof may be utilized. One commercially available zinc-containing compound is Tego®SorbPY88 TQ, zinc ricinoleate pellets available from Evonik Industries AG of Essen, Germany.

The present invention further relates to a non-oxidizing (as defined in class 5 division 5.1 solid oxidizer test) cleaning composition that contains peroxide moieties and the method for making the cleaning composition. Peroxides have a bleaching effect on organic substances and therefore are often added to some detergents in the form of an oxidizing agent. Sodium percarbonate is a commonly used such oxidizing ingredient in home and laundry cleaning products. When dissolved in water, sodium percarbonate decomposes to hydrogen peroxide and sodium carbonate. However, sodium percarbonate (and compositions containing sodium percarbonate) is known to have poor storage stability and additive(s) have typically been added to coat the sodium percarbonate and reduce its sensitivity to moisture. These additives include metaboric acid, boric acid and borates (U.S. Pat. No. 5,658,873; EP0567140), alkali metal or alkali earth metal silicate, carbonate, sulfate, nitrate and chloride (U.S. Pat. No. 4,325,933; U.S. Pat. No. 5,851,420; U.S. Pat. No. 5,462,804; EP 0634482), as well as mono and dicarboxylic acids (EP0407189).

While these coating additives improve storage stability, sodium percarbonate is still a class 5 division 5.1 solid oxidizer. Thus, exposure to moisture and/or certain temperatures may trigger self-accelerating decomposition of the sodium percarbonate, which may cause the undesirable release of heat and oxygen.

Therefore, there is still a need for a solid cleaning composition containing a majority component of peroxide moieties that is a non-oxidizer according to class 5 division 5.1 classification.

Thus, the present invention further includes a solid cleaning composition in a film-encased form containing a majority by weight of a peroxygen ingredient that is a non-oxidizing Class 5 Division 5.1 solid. The composition may contain at least one flame retardant. In addition, the cleaning formulation leaves no solid residue when used in a cleanout cycle of a high efficiency washer (the tub of the washing machine or other appliance is substantially residue-free after the cleaning cycle).

The non-oxidizing cleaning composition that contains a peroxide generating ingredient is comprised of a majority by weight of an oxidizing agent. As described herein, oxidizing agents include those materials that decompose in water and release hydrogen peroxide. Suitable oxidizing agents include percarbonate, perborate, persulfate, perphosphate, persilicate, and mixtures thereof.

The film-encased cleaning composition is comprised of granular powder particles. The average particle size of the components of the granular composition in accordance with the invention, in one aspect, should be such that no more than 5% of the particles are greater than 1.7 mm in diameter and not more than 5% of the particles are less than 0.5 mm in diameter. The term “average particle size” as defined herein is calculated by sieving a sample of the composition into a number of fractions (typically 5 fractions) on a series of Tyler sieves. The weight fractions thereby obtained are plotted against the aperture size of the sieves. The average particle size is taken to be the aperture size through which 50% by weight of the sample would pass.

In another aspect, the particles may be of uniform or non-uniform size. It may be desirable that the particle shape be greater than one-quarter of an inch in size so that the granulated particles will not fall through the holes in the bottom of the wash tub.

Formation of the granular powder cleaning composition may be achieved by generally standard processes known in the art for creating granulated particles. If the ingredients of the composition are provided in liquid form, then they should be dehydrated by any means known to those skilled in the art for removing liquid from a composition. For instance, dehydration may be accomplished by heating the composition, such as in a hot air oven, by evaporation, by exposure to an infrared source, and the like, and combinations thereof.

After dehydration of the cleaning composition, the dry residue that remains may be combined with other ingredients, such as those described previously, and formed into the desired particle shape and size. Such shape manipulation may be performed by any means known for forming particles. After formation of the granulated particles, other additives may be added to the outside of the particles.

The thus produced granulated powder particles are then encased in a polymeric film material. Such encasement is achieved by methods known to those skilled in the art of making sealed pouches.

The film-encased cleaning composition (or pouch) is ideal for use in cleaning appliances, such as automatic washing machines and dishwashing machines. One advantage of the pouch described herein is the softness exhibited by the surface of the pouch, in contrast to hard cleaning tablets or pucks. Cleaning tablets or pucks have been known to dent the interior wash tub of automatic washing machines. Therefore, the use of a soft, film-encased cleaning composition is an advantage over the prior art.

Many factors need to be taken into consideration when construction the film-encased cleaning composition described herein. For example, the dissolution rate of the pouch needs to be determined and calculated based on the end-use application of the pouch. More specifically, in one aspect, the pouch should not dissolve significantly during the first rinse cycle in washing machines that include a built-in cleaning cycle. After the first rinse cycle, the second rinse cycle will begin and the pouch should be designed to dissolve completely during this second rinse cycle for optimum cleaning of the washing machine. Ideally, the pouch, and the granular particles contained therein, should dissolve substantially completely in either hot water or cold water and should contain ingredients which are not detrimental to the machine or the clothing that will be put into the machine after a cleaning cycle has been performed.

Other features of the film-encased cleaning composition, such as particle size and overall size of the pouch, should be considered. More specifically, the granular powder cleaning composition should not leave the wash tub through the drain holes in the wash tub. The pouch should be of a small enough size and weight that it does not set off the weight sensors that are built into the cleaning cycle of the washing machine. The cleaning cycle is designed to sense whether there are clothes in the machine at the beginning of the cycle. If there is a film-encased cleaning pouch in the wash tub that is too large, the weight sensors will detect it and send a signal to the machine that a normal wash cycle should occur rather than the cleaning cycle. Such a situation would result in wasted cleaning products, water, and energy.

### EXAMPLES

The file-encased cleaning compositions of the invention, methods of preparation and evaluation are demonstrated in the following examples for the purpose of providing more detailed information and illustrating the advantages of the present invention over the current state of the art. The following Examples are provided for illustration purposes only and are not to be construed as limiting in any way the scope of the invention as defined by the appended claims.

Sample Preparation

The granular cleaning compositions having the following formulations were prepared:

Granular Formulation 1:

| Formulation | Percentage Weight | Grams (200 grams) |
|---|---|---|
| EDTA (Versene 220) | 3.80% | 7.60 g |
| Soda Ash Light | 12.50% | 25.0 g |
| Boric Acid Powder | 21.20% | 42.4 g |
| Plurocol P425 | 1.00% | 2.0 g |
| Fragrance | 0.50% | 1.0 g |
| Sodium Percarbonate | 61.00% | 122.0 g |

Granular Formulation 2:

| Formulation | Percentage Weight | Grams (100 grams) |
|---|---|---|
| Tartaric Acid | 9.50% | 9.5 g |
| Fragrance | 0.50% | 0.5 g |
| Sodium Percarbonate | 90.00% | 90.0 g |

Granular Formulation 3:

| Formulation | Percentage Weight | Grams (100 grams) |
|---|---|---|
| Tartaric Acid | 10.00% | 10.0 g |
| Fragrance | 0.50% | 0.5 g |
| Sorbitol | 29.50% | 29.5 |
| Sodium Percarbonate | 60.00% | 60.0 g |

Formulation 1 is a comparative cleaning composition similar to the composition described as “Formulation 14” in US 2009/0032063A1, and was prepared accordingly.

Formulations 2 and 3 are cleaning compositions of this disclosure and were prepared as follows:

The sodium percarbonate was sifted and placed in a quart size bag. The fragrance was then added to the sodium percarbonate and the bag was tumbled for several minutes to ensure uniform mixing. The tartaric acid was then added and the bag was tumbled again. The sorbitol (Formulation 3) was then added and the bag was tumbled again.

Granular Formulations 1, 2 and 3 were encased in one or more of the films described herein.

Each of Films A, B and C was a solution cast, polyvinyl alcohol-based, thermoplastic film having a thickness of 76 microns (available from MonoSol, LLC of Merrillville, Ind.).

Example 1—Formulation 1 encased in Film A.

Example 2—Formulation 1 encased in Film B.

Example 3—Formulation 1 encased in Film C.

Example 4—Formulation 2 encased in Film A.

Example 5—Formulation 2 encased in Film B.

Example 6—Formulation 3 encased in Film A.

Example 7—Formulation 3 encased in Film B.

Testing and Test Results

Each film-encased cleaning composition (or pouch), Examples 1-7, was subjected to environmental testing by placing each sample in a labeled high density polyethylene (HDPE) jar and closing each jar with a cap. Each sample was tested at (1) ambient temperature and humidity and at (2) 38° C. with 80% relative humidity. The samples were evaluated after 14 days in such conditions.

Film solubility was conducted using distilled water at 10° C. for 300 seconds.

### Examples 1-3

Visual observation of Examples 1, 2 and 3 showed no film or product discoloration. Pouch inflation occurred and granular product was adhered to the interior film surface with some dimpling of the film. The granular cleaning composition mostly solidified upon storage in the 38° C. with 80% relative humidity environment. Films exhibit poor tear resistance and an inability to be stretched. The granular cleaning composition was successfully contained within the film.

Film solubility testing, as determined by ATR spectra, showed alteration of structures necessary to maintain solubility. Plasticizer content could not be calculated due to the inability to thin the films adequately for transmission sampling. Film moisture values were virtually unchanged. These samples failed the disintegration test, i.e. the samples were incapable of dissolving within a desired 300 second time frame. Therefore, Granular Formulation 1 was not suitable for use within Films A, B and C.

### Examples 4-5

Visual observation of Examples 4 and 5 showed much product adhesion with areas of white film discoloration due to product crusting on the film surface. Film flexibility (e.g. ability to stretch film) was unchanged. The granular cleaning composition was successfully contained within the film.

Film solubility testing, as determined by ATR spectra, showed alteration of structures necessary to maintain solubility. Plasticizer content exhibited an average reduction of 20% in Example 4 and 13% in Example 5. Film moisture values were increased 2% in both Examples 4 and 5. All samples passed the disintegration test, i.e. the samples were capable of dissolving within a desired 300 second time frame, except for Example 5 in the 38° C. with 80% relative humidity environment.

### Examples 6-7

Visual observation of Examples 6 and 7 showed some product adhesion but no areas of film or product discoloration. Film flexibility (e.g. ability to stretch film) was unchanged. The granular cleaning composition was successfully contained within the film.

Film solubility testing, as determined by ATR spectra, showed alteration of structures necessary to maintain solubility. Plasticizer content exhibited an average reduction of 25% in Example 6 and 20% in Example 7. Film moisture values were increased 1% in both Examples 6 and 7. All samples passed the disintegration test, i.e. the samples were capable of dissolving within a desired 300 second time frame.

Additional Examples were made using the formulations below:

Granular Formulation 4:

| Formulation | Percentage Weight | Grams (100 grams) |
|---|---|---|
| Sodium Percarbonate | 60% | 60.0 g |
| Sodium Carbonate | 4% | 4.0 g |
| DL—Tartaric Acid | 5% | 5.0 g |
| Fragrance | 0.5% | 0.5 g |
| Propylene Glycol 425 | 1% | 1.0 g |
| Methyl Oxirane Polymer | 0.5% | 0.5 g |
| with Oxirane | | |
| Vinylpyrrolidone-vinyl | 2% | 2.0 g |
| acetate copolymer | | |
| Sodium Metasilicate | 5.0% | 5.0 g |
| Pentahydrate | | |
| Sodium Benzoate | 2.0% | 2.0 g |
| Sodium Sulfate | 10.0% | 10.0 g |
| Magnesium Sulfate | 10.0% | 10.0 g |

Granular Formulation 5:

| Formulation | Percentage Weight | Grams (100 grams) |
|---|---|---|
| Sodium Percarbonate | 60% | 60.0 g |
| Sodium Carbonate | 1% | 1.0 g |
| DL—Tartaric Acid | 4% | 4.0 g |
| Fragrance | 0.5% | 0.5 g |
| Polypropylene Glycol 425 | 1% | 1.0 g |
| Methyl Oxirane Polymer | 0.5% | 0.5 g |
| with Oxirane | | |
| Zinc Ricinoleate | 1.0% | 1.0 g |
| Zinc Undecylenate | 1.0 % | 1.0 g |
| Vinylpyrrolidone-vinyl | 2% | 2.0 g |
| acetate copolymer | | |
| Sodium Metasilicate | 5.0% | 5.0 g |
| Pentahydrate) | | |
| Sodium Benzoate | 1.0% | 1.0 g |
| Sodium Sulfate | 10.0% | 10.0 g |
| Magnesium Sulfate | 13.0% | 13.0 g |

Each of Films D (M8630) and E (M8310) was a solution cast, polyvinyl alcohol-based, thermoplastic film having a thickness of 38 microns (available from MonoSol, LLC of Merrillville, Ind.).

Example 8 is a film encased cleaning composition of Formulation 4 and Film D.

Example 9 is a film encased cleaning composition of Formulation 4 and Film E.

Example 10 is a film encased cleaning composition of Formulation 5 and Film D.

Example 11 is a film encased cleaning composition of Formulation 5 and Film E.

Formulations 4 and 5 are cleaning compositions of this disclosure and were prepared as follows:

The sodium carbonate and tartaric acid was placed in a quart size bag and tumbled for several minutes. The sodium sulfate was then added to the bag and tumbled for several minutes. The magnesium sulfate was then added and the bag was tumbled again. After these powder materials were homogenously mixed, then the Pluronic® L-81, PPG 425 and fragrance were added to the bag and tumbled until uniformly mixed. The polyvinylpyrrolidone and the sodium metasilicate pentahydrate were next added to the bag and mixed. Next, the zinc-containing compounds were added to the bag and mixed (for Formulation 5 only). The sodium percarbonate was next added to the bag and tumbled again. Finally, the sodium benzoate was added to the bag and tumbled for 3 minutes.

Each of Examples 8 through 11 was tested for various parameters in three different environments: at ambient temperature and humidity, at 38° C. and 80% relative humidity, and at 38° C. and 10% relative humidity. Visible evaluation of the samples was made at day zero (unexposed), at day 14, at day 28, and at day 42 (only for the 38° C. and 10% relative humidity environment).

Test Results:

For Example 8, in all three environments, visual observation of the samples showed: (a) no visible film or product discoloration, (b) flexibility appeared only slightly reduced upon exposure to all environments, and (c) the product (granular detergent powder) was successfully contained within the film in all three environments.

Elongation at break was also tested. The results are as follows:

Elongation of Example 8

| Average/Std. Deviation, n = 3 | Elongation at Break (%) |
|---|---|
| Unexposed | 392/47 |
| 42 days @ 23° C., 50% RH | 397/35 |
| 42 days @ 38° C., 80% RH | 276/70 |
| 42 days @ 38° C., 10% RH | 291/37 |

Elongation values of the exposed film were unaffected under ambient conditions (23° C., 50% RH) while slightly reduced in the 38° C. environments when compared with the virgin, unexposed material.

Film solubility tests were conducted in distilled water at 10° C. in all three environments, according to the MonoSol Standard Test Method 205. The results are as follows:

Film Solubility of Example 8

| | Complete | |
|---|---|---|
| | Solubility | Disintegration |
| Average/Std. Deviation | Time (seconds) | Time (seconds) |
| Unexposed | 22/1 | 9/0 |
| 14 days @ ambient temperature and RH | 27/3 | 11/0 |
| 28 days @ ambient temperature and RH | 33/4 | 11/1 |
| 42 days @ ambient temperature and RH | 24/1 | 11/1 |
| 14 days at 38° C., 80% RH | 33/3 | 13/1 |
| 28 days @ 38° C., 80% RH | 38/3 | 13/1 |
| 42 days @ 38° C., 80% RH | 35/5 | 14/1 |
| 42 days @ 38° C., 10% RH | 24/1 | 13/1 |

The test results illustrate that minimal elevation of time is required to initiate disintegration and complete solubility following product exposure within all test environments.

For Example 9, in all three environments, visual observation of the samples showed: (a) no visible film or product discoloration, (b) flexibility appeared somewhat reduced upon exposure to all environments, and (c) the product (granular detergent powder) was successfully contained within the film in all three environments.

Elongation at break was also tested. The results are as follows:

Elongation of Example 9

| Average/Std. Deviation, n = 3 | Elongation at Break (%) |
|---|---|
| Unexposed | 422/19 |
| 42 days @ 23° C., 50% RH | 305/124 |
| 42 days @ 38° C., 80% RH | 180/89 |
| 42 days @ 38° C., 10% RH | 267/31 |

Elongation values of the exposed film were decreased under all test conditions when compared with the virgin, unexposed material.

Film solubility tests were conducted in distilled water at 10° C. in all three environments, according to the MonoSol Standard Test Method 205. The results are as follows:

Film Solubility of Example 9

| | Complete | Disintegration |
|---|---|---|
| | Solubility Time | Time |
| Average/Std. Deviation | (seconds) | (seconds) |
| Unexposed | 29/1 | 15/1 |
| 14 days @ ambient temperature and RH | 36/2 | 16/1 |
| 28 days @ ambient temperature and RH | 35/1 | 16/1 |
| 42 days @ ambient temperature and RH | 30/2 | 16/1 |
| 14 days at 38° C., 80% RH | 40/2 | 20/1 |
| 28 days @ 38° C., 80% RH | 55/8 | 25/3 |
| 42 days @ 38° C., 80% RH | 49/3 | 28/2 |
| 42 days @ 38° C., 10% RH | 28/1 | 16/2 |

The test results illustrate minor elevation of time is required to initiate disintegration and complete solubility following product exposure within the 38° C., 80% RH test environment.

For Example 10, in all three environments, visual observation of the samples showed: (a) no visible film or product discoloration, (b) flexibility appeared only slightly reduced upon exposure to all environments, and (c) the product (granular detergent powder) was successfully contained within the film in all three environments.

Elongation at break was also tested. The results are as follows:

Elongation of Example 10

| Average/Std. Deviation, n = 3 | Elongation at Break (%) |
|---|---|
| Unexposed | 392/47 |
| 42 days @ 23° C., 50% RH | 394/20 |
| 42 days @ 38° C., 80% RH | 244/40 |
| 42 days @ 38° C., 10% RH | 260/18 |

Elongation values of the exposed film were unaffected under ambient conditions (23° C., 50% RH) while reduced in the 38° C. environments when compared with the virgin, unexposed material.

Film solubility tests were conducted in distilled water at 10° C. in all three environments, according to the MonoSol Standard Test Method 205. The results are as follows:

Film Solubility of Example 10

| | Complete Solubility | Disintegration |
|---|---|---|
| Average/Std. Deviation | Time (seconds) | Time (seconds) |
| Unexposed | 22/1 | 9/0 |
| 14 days @ ambient temperature | 23/1 | 10/1 |
| and RH | | |
| 28 days @ ambient temperature | 31/2 | 11/0 |
| and RH | | |
| 42 days @ ambient temperature | 23/4 | 11/1 |
| and RH | | |
| 14 days at 38° C., 80% RH | 32/2 | 11/1 |
| 28 days @ 38° C., 80% RH | 43/8 | 14/2 |
| 42 days @ 38° C., 80% RH | 35/1 | 13/2 |
| 42 days @ 38° C., 10% RH | 24/2 | 12/1 |

The test results illustrate that minimal elevation of time is required to initiate disintegration and complete solubility following product exposure within all test environments.

For Example 11, in all three environments, visual observation of the samples showed: (a) no visible film or product discoloration, (b) flexibility appeared only slightly reduced upon exposure to all environments, and (c) the product (granular detergent powder) was successfully contained within the film in all three environments.

Elongation at break was also tested. The results are as follows:

Elongation of Example 11

| Average/Std. Deviation, n = 3 | Elongation at Break (%) |
|---|---|
| Unexposed | 422/19 |
| 42 days @ 23° C., 50% RH | 412/36 |
| 42 days @ 38° C., 80% RH | 119/51 |
| 42 days @ 38° C., 10% RH | 329/70 |

Elongation values of the exposed film were unaffected under ambient conditions (23° C., 50% RH) while reduced in the 38° C. environments when compared with the virgin, unexposed material.

Film solubility tests were conducted in distilled water at 10° C. in all three environments, according to the MonoSol Standard Test Method 205. The results are as follows:

Film Solubility of Example 11

| | Complete | Disintegration |
|---|---|---|
| | Solubility Time | Time |
| Average/Std. Deviation | (seconds) | (seconds) |
| Unexposed | 29/1 | 15/1 |
| 14 days @ ambient temperature and RH | 30/0 | 16/1 |
| 28 days @ ambient temperature and RH | 40/3 | 17/1 |
| 42 days @ ambient temperature and RH | 27/2 | 14/2 |
| 14 days at 38° C., 80% RH | 38/1 | 20/2 |
| 28 days @ 38° C., 80% RH | 55/6 | 29/5 |
| 42 days @ 38° C., 80% RH | 53/6 | 29/1 |
| 42 days @ 38° C., 10% RH | 29/1 | 17/1 |

The test results illustrate minor elevation of time is required to initiate disintegration and complete solubility following product exposure within the 38° C., 80% RH test environment.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A film-encased cleaning composition comprised of:
(a) a granular cleaning material, wherein the cleaning material is comprised of:
(i) a majority by weight of a percarbonate-based compound;
(ii) an organic acid component;
(iii) a metal chelating agent; and
(iv) optionally, at least one component selected from the group consisting of a diluent, a filler, a preservative, an anti-corrosion agent, and a fragrance;
and
(b) a film component, wherein the film component is polymeric, and wherein the film forms an enclosure that surrounds the granular cleaning material such that the granular cleaning material is contained within the film enclosure.

2. The film-encased cleaning composition of claim 1, wherein the percarbonate-based compound is present in the range from 1% to 95% by weight of the composition.

3. The film-encased cleaning composition of claim 1, wherein the percarbonate-based compound is sodium percarbonate.

4. The film-encased cleaning composition of claim 1, wherein the metal chelating agent is an organic acid.

5. The film-encased cleaning composition of claim 4, wherein the organic acid is the same organic acid as component (ii) of claim 1.

6. The film-encased cleaning composition of claim 1, wherein the organic acid component is present in the range from 0.001% to 60% by weight of the composition.

7. The film-encased cleaning composition of claim 1, wherein the organic acid component is carboxylic acid.

8. The film-encased cleaning composition of claim 7, wherein carboxylic acid is selected from the group consisting of citric acid, tartaric acid, succinic acid, fumaric acid, malic acid, gluconic acid, aspartic acid, adipic acid, lactic acid, and mixtures thereof.

9. The film-encased cleaning composition of claim 1, wherein the film component is selected from the group consisting polyvinyl alcohol, polyethylene, polypropylene, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, natural gums, and combinations thereof.

10. The film-encased cleaning composition of claim 1, wherein the film component has a thickness in the range from 1 to 300 microns.

11. The film-encased cleaning composition of claim 1, wherein the average particle size of the components comprising the granular material is characterized in that no more than 5% of the particles are greater than 1.7 mm in diameter and not more than 5% of the particles are less than 0.5 mm in diameter.

12. The film-encased cleaning composition of claim 1, wherein at least one of the filler or diluent is a carbonate-based compound.

13. The film-encased cleaning composition of claim 1, wherein the granular cleaning material further includes a polyol compound.

14. The film-encased cleaning composition of claim 13, wherein the polyol compound is sorbitol.

15. The film-encased cleaning composition of claim 1, wherein the granular cleaning material further includes a sugar compound.

16. The film-encased cleaning composition of claim 15, wherein the sugar compound is dextrose.

17. The film-encased cleaning composition of claim 1, wherein the granular cleaning material further includes a polyol compound and a sugar compound.

18. The film-encased cleaning composition of claim 17, wherein the polyol compound is sorbitol and the sugar compound is dextrose.

19. The film-encased cleaning composition of claim 1, wherein the metal chelating agent is carboxylic acid.

20. The film-encased cleaning composition of claim 19, wherein the carboxylic acid is tartaric acid.
